(19) United States
(12) Patent Application Publication
(10) Pub. No.: US 2025/0147672 A1
(43) Pub. Date: May 8, 2025

(54) Method and System of Dynamic Loading of Software from External Flash

(71) Applicant: TEXAS INSTRUMENTS INCORPORATED, Dallas, TX (US)

(72) Inventors: Mihir Narendra Mody, BANGALORE (IN); Prithvi Shankar Y.A., BANGALORE (IN); Sriramakrishnan Govindarajan, BANGALORE (IN); Mohd Asif Farooqui, BANGALORE (IN); Shailesh Ganapat Ghotgalkar, BANGALORE (IN); Sai Karthik Rajaraman, FRISCO, TX (US); Pratheesh Gangadhar TK, BANGALORE (IN); David Smith, Allen, TX (US); Niraj Nandan, Plano, TX (US)

(21) Appl. No.: 18/591,959

(22) Filed: Feb. 29, 2024

Related U.S. Application Data
(60) Provisional application No. 63/547,177, filed on Nov. 3, 2023.

(51) Int. Cl. G06F 3/06

(52) U.S. Cl. CPC G06F 3/0617; G06F 3/065; G06F 3/0659; G06F 3/0679

(57) ABSTRACT

Systems and methods for servicing read requests may include receiving a transaction from a processing unit while mirroring contents from an external memory to an on-chip RAM. Such systems and methods may monitor a progress of the mirroring and, based on the monitoring, access code or data values for the transaction from either the external memory or the on-chip RAM. Such systems and methods may further provide the code or data values to the processing unit according to the transaction. Such systems and methods may allow for execution of software before software has been fully downloaded to internal memory.

### CROSS-REFERENCE TO RELATED APPLICATIONS

This application claims priority to U.S. Provisional Patent Application 63/547,177, filed Nov. 3, 2023, the disclosure of which is hereby incorporated by reference herein.

### TECHNICAL FIELD

The present disclosure relates generally to loading software code from external memory and, more specifically, to allowing a processor to access the code from the external memory or an on-chip memory based on progress of the loading.

### BACKGROUND

Some systems-on-chip (SoCs) include multiple microcontroller units and internal flash memory. However, technology has advanced to a point where the transistors of the microcontroller units may use more advanced process nodes than the transistors associated with flash technology. That has resulted in a scenario in which more advanced SoCs may move away from internal flash memory and toward external flash memory, thereby allowing the flash memory to be manufactured using technology different from the technology used for the microcontroller units. However, disposing flash off-chip may come with drawbacks. For instance, off-chip flash may be accessed by external buses, which may in some instances be slower than on-chip buses, thereby resulting in slower access of code and data values from the off-chip flash. As a result, boot up from external flash may be associated with some amount of latency. Latency may or may not be appropriate for some applications.

### SUMMARY

In one example, a method includes: receiving a transaction from a processing unit while mirroring contents from an external memory to an on-chip random access memory (RAM); monitoring a progress of the mirroring; determining, based on the monitoring, to access code or data values for the transaction from either the external memory or the on-chip RAM; and providing the code or data values to the processing unit according to the transaction.

In another example, a system-on-chip (SoC) includes: a central processing unit (CPU); on-chip random-access memory (RAM); and hardware logic disposed within a communication path between the CPU and the on-chip RAM, wherein the hardware logic is configured to: perform a mirroring operation on application code from an external memory to the on-chip RAM; receive a request from the CPU, wherein the request references an address in the on-chip RAM; determine that the address referenced by the request has not yet been written by the mirroring operation; and respond to the request by accessing the application code from the external memory.

In yet another example, a software programming tool includes: a compiler configured to: produce machine code instructions and produce pseudo-addresses for the machine code instructions, further wherein the machine code instructions correspond to a software application; and a linker configured to: receive the machine code instructions from the compiler; perform a test run on the software application, including determining an execution order of a plurality of discrete software functions of the software application; and write the machine code instructions to a nonvolatile memory, including writing the machine code instructions according to the execution order of the plurality of discrete software functions.

### BRIEF DESCRIPTION OF THE DRAWINGS

Having thus described the invention in general terms, reference will now be made to the accompanying drawings, wherein:

FIG. 1 is an illustration of an example system, having a hardware module for firmware updates, according to various embodiments.

FIG. 2 is an illustration of various functional components of the system of FIG. 1, according to various embodiments.

FIG. 3 is an illustration of an example method of instruction and data fetching, according to various embodiments.

FIG. 4 is an illustration of an example method of instruction and data fetching, according to various embodiments.

FIG. 5 is an illustration of an example method including a compiler and linker placing machine code and data values, according to various embodiments.

FIG. 6 is an illustration of an example method in which a compiler and linker place machine code and data values, according to various embodiments.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Corresponding numerals and symbols in the different figures generally refer to corresponding parts, unless otherwise indicated. The figures are not necessarily drawn to scale. In the drawings, like reference numerals refer to like elements throughout, and the various features are not necessarily drawn to scale.

Some automotive and industrial microcontroller units are moving to an architecture that includes multiple smaller microcontroller units consolidated into a single higher-performance microcontroller unit. The higher-performance microcontroller units may employ advanced processing nodes to support higher central processing unit (CPU) speeds. However, embedded flash migration to lower process nodes may be costly and difficult in some instances and, thus, some applications instead employ a higher-performance microcontroller unit that works with an external flash. A microcontroller unit may execute code from the external flash using a process called execute in place (XIP).

One approach to using external flash includes mirroring data from the external flash to on-chip random-access memory (RAM). This process is sometimes referred to as “image download.” The processing units may then execute code and access data values from the on-chip RAM. As noted above, another approach is to execute code and data values from the external flash using XIP. Both approaches have advantages and drawbacks.

For instance, mirroring the code to on-chip RAM may allow for relatively fast execution of the code. In one example, the processing units on the chip may take advantage of on-chip buses that link the processing units to the on-chip RAM and allow quick access to the data values and code. However, such approaches may come at the cost of relatively long boot times. For instance, the boot times may be affected by a time duration of the image download.

Looking at XIP approaches, they may reduce an amount of boot time by allowing the code to be executed and data values to be accessed without waiting for a mirroring operation to complete. However, the relatively short boot time may be accompanied by relatively slow processing times because access to the code and data values may be through off-chip buses.

In contrast, various embodiments may be configured to provide relatively short boot times as well as relatively quick execution speed by beginning execution of code during a mirroring operation, such as an image download, from an external memory to an on-chip RAM. For instance, various embodiments may include receiving a transaction from a processing unit (e.g., CPU of a system on-chip). The transaction may be received during the mirroring operation. The system on-chip (SoC) may further include logic that monitors a progress of the mirroring operation. The logic may determine, based on its monitoring, to access code or data values for the transaction from either the external memory or the on-chip RAM.

Continuing with the example, if the logic recognizes that the code and data values associated with the transaction have been written to the on-chip RAM, then the logic may cause the code and data values to be accessed from the on-chip RAM. However, if the logic recognizes that the code and data values associated with the transaction have not yet been written to the on-chip RAM, then the logic may cause the code and data values to be accessed via XIP.

Further in the example, the mirroring operation may continue until the contents to be mirrored has completed being written to the on-chip RAM (e.g., the image download is complete). After that, any accesses to the mirrored contents may be from the on-chip RAM. Of course, various embodiments may be adapted for data values and code that is not mirrored to the on-chip RAM and may, instead, be accessed via XIP. For instance, code and data values may be segregated into regions, where some regions are designated for mirroring to on-chip RAM and other regions are designated for XIP. The code and data values designated for mirroring may be subject to the method briefly described above—that is, during download, it may be accessed for a transaction by a processing unit from either the on-chip RAM or the external memory depending upon the progress of the mirroring.

Various embodiments may include advantages over other solutions. For instance, allowing data values and code to be accessed either from on-chip RAM or external memory, during a mirroring operation and based upon progress of the mirroring operation, may allow for a relatively quick boot time. Specifically, the code and data values that have been downloaded to the on-chip RAM first may be accessed relatively quickly because it may be available on RAM before the full download has been performed. Furthermore, the code and data values that have been downloaded to the on-chip memory may be accessed from the on-chip RAM using internal buses and internal clocking, thereby providing relatively fast execution. Furthermore, code and data values that have not yet been downloaded to the RAM may still be accessed, thereby allowing for full functionality during the mirroring operation. Such features may allow for more efficient operation of a computing device by reducing latency.

Additionally, some embodiments may include a compiler that is configured to produce machine code, read-only data values, and read and write data values. The compiler may be further configured to produce pseudo-addresses for the machine code, the read-only data values, and the read and write data values. The machine code, the read-only data values, and the read and write data values may correspond to a software application. Such embodiments may further include a linker that is configured to receive the machine code, the read-only data values, and the read and write data values from the compiler. The linker may be further configured to perform a test run on the software application, including determining an execution order of a plurality of discrete software functions of the software application. The linker may be further configured to write the machine code, the read-only data values, and the read and write data values to a nonvolatile memory, such as an external (off-chip) memory of a SoC. This may include writing the machine code and data values according to the execution order of the plurality of discrete software functions.

As a result, the machine code and data values may be written into memory cells of the external memory in an order that corresponds to an execution order of the plurality of discrete software functions. Of course, the compiling and linking precedes a deployed usage of the SoC that is associated with the external memory. During deployed usage, and, more specifically, during boot time of the SoC, the SoC may begin image download. The mirroring operation of the image download may move the data in the same order in which the data is written into the memory cells of the external memory. In other words, the mirroring operation may download code and data values in an order in which the code and data values is expected to be accessed by transactions associated with execution of the software application.

As discussed above, some embodiments may include logic on the SoC configured to copy code and data values from an external memory to an on-chip RAM and logic on the SoC configured to determine whether to access code and data values from the on-chip RAM or from the external memory based upon whether that code and data values have been written to the on-chip RAM. The compiling and linking process described above may increase the chances that a particular portion of code and data values may be available from on-chip RAM in response to a transaction, even during an early portion of the mirroring operation. Put another way, if accessing the code and data values from on-chip RAM is a hit, and accessing the code and data values via XIP is a miss, then ordering the code and data values into the memory cells, as described above, may increase hits and decrease misses. Of course, execution of software may be non-linear in some instances, such as due to branching instructions. Therefore, hits or misses may not be entirely guaranteed in some situations. Nevertheless, writing the machine code and data values into memory cells of the external memory in an order that corresponds to an execution order of the plurality of discrete software functions may increase an efficiency of a computer system by increasing the likelihood that code or data values may be accessed from on-chip RAM even before a mirroring operation is complete.

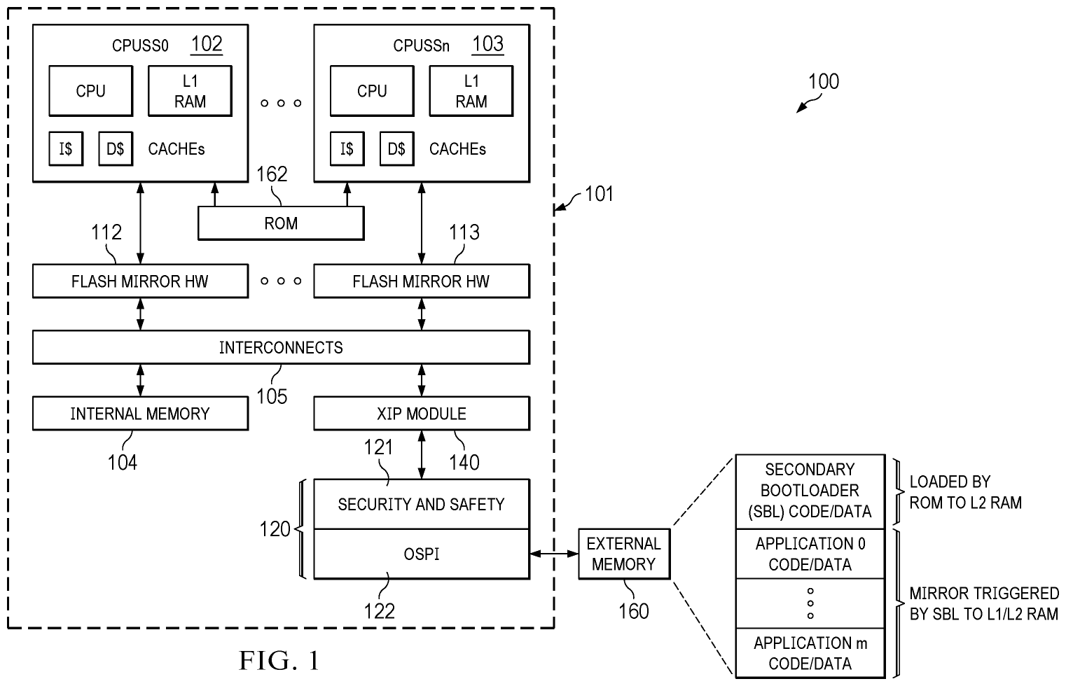

FIG. 1 is an illustration of an example system 100, having example mirroring hardware 112, 113 according to various embodiments. The example system includes a system-on-chip (SoC) 101 coupled to an external memory 160, which may be implemented as Flash memory or other appropriate memory hardware, and a read-only memory (ROM) 162, which may be implemented as any appropriate memory hardware. According to some embodiments, the SoC 101 may include multiple (n) processing cores 102-103. External memory 160 may include non-transitory memory and may store data values and machine code instructions for execution by the processing cores 102-103 or may be another memory type for which lower latency memories are available in a memory hierarchy. In the example of FIG. 1, external memory 160 may store a variety of different machine code and data values, some of which may be designated for mirroring and some may be designated for XIP.

SoC 101 may be fabricated on a semiconductor die and may be included within a semiconductor package in some implementations. Further, the external memory 160 may be part of a separate semiconductor die or semiconductor package. However, the scope of implementations is not limited to any particular physical architecture for chip and package structures.

In addition to accessing data values and machine code instructions from external memory 160, the processing cores 102-103 may access data values and machine code instructions from internal memory 104 (e.g., L2 RAM). The instructions stored in internal memory 104 may include parts of one or more software programs. Software programs may be developed, encoded, and compiled in a variety of computing languages for a variety of software platforms and/or operating systems and subsequently loaded and executed by processing cores 102-103. In some embodiments, the compiling process of the software program may transform program code written in a programming language to another computer language such that the processing cores 102-103 are able to execute the programming code. For example, the compiling process of the software program may generate an executable program that provides encoded instructions (e.g., machine code instructions) for processing cores 102-103 to accomplish specific, non-generic, particular computing functions. The encoded instructions may be loaded as computer-executable instructions from memory 104. Furthermore, the compiling process may generate read-only data values, such as constants, and read-write data values, such as variables.

The SoC 101 may also include an execute-in-place (XIP) module 140. Generally, the XIP module 140 is a functional block that acts as a proxy for requests from the processing cores 102-103 to regions of memory, such as external memory 160 or the like. According to some embodiments, the XIP module 140 includes one or more counters to track calls to various memory locations of the external memory 160. In some embodiments, a counter may be provided for each memory region, or slice, that is tracked. Similar to, but distinct from the caches of the processors, the XIP module 140 may copy machine code and data values from a slower memory to a faster memory. However, in contrast to the internal memory 104, the XIP module 140 may store the copied content in a number of different types of memory scattered about the SoC 101, and also may selectively mirror content. That is, the XIP module 140 is configured to intercept and redirect memory calls, and also maintains and selectively mirrors memory blocks from memory devices throughout a system, such as on SoC 101, on memory external to the XIP module 140, and the like. XIP module 140 may also be configured to service transactions directly from the external memory 160 by, e.g., translating an address as appropriate to access a desired portion of external memory 160.

In some embodiments, the XIP module 140 may include logic which causes portions of the computer code stored in memory blocks of external memory 160 to be copied to other memory locations on memory devices associated with lower latency, such as memory 104. In addition, XIP module 140 may be configured to store a table of mapped memory locations when portions of the code are copied from external memory 160 onto other memory locations. Accordingly, when the processing cores 102-103 provide a transaction directed to a memory location on the target memory, the XIP module 140 may intercept the transaction, determine whether the code associated with the memory location has been mirrored to another, closer memory location, and if so, remap the transaction address. For example, if a particular line of code has been mirrored to an on-chip memory location (e.g., in memory 104), the XIP module 140 may remap the location and cause the transaction to be performed with the on-chip memory location, thereby circumventing longer latency associated with calls to the external memory 160.

The processing units 102-103 are communicatively coupled to various other components via the interconnects 105. Interconnects 105 may include a multitude of buses or other signal-conducting components to allow the various components to communicate with each other. For instance, the processing units 102-103 may be communicatively coupled to internal memory 104, flash controller 120, and XIP module 140 via interconnects 105.

Flash controller 120 may include hardware logic that is coupled with external memory 160 to provide lower-level hardware control over external memory 160. For instance, flash controller 120 may receive instructions from XIP module 140 to read or write to the external flash 160. In one example, processing units 102-103 may perform read and write operations to the external memory 160 via XIP module 140. Flash controller 120 may operate according to any appropriate protocol, such as Quad serial peripheral interface (SPI), Octal SPI (OSPI), XSPI, parallel interface, or the like, as illustrated by OSPI module 122. Additionally, flash controller 120 includes safety and security module 121, which may perform error correction coding (ECC) operations, security verification of code, and the like.

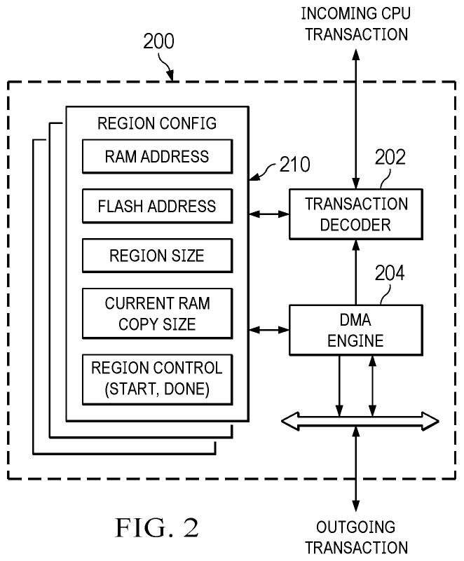

Mirroring hardware 112, 113 may be implemented so that a particular instance of mirroring hardware is in the communication path of a respective one of the n processing units 102, 103. Mirroring hardware 112, 113 may be implemented on SoC 101 as hardware logic. For instance, each mirroring hardware 112, 113 include a microcontroller unit (MCU), a CPU, or other appropriate processing hardware. In the example of FIG. 1, mirroring hardware 112, 113 is dedicated hardware for code and data values mirroring, where mirroring may include reading code and data values from one or more banks of external memory 160 via flash controller 120 and then performing write operations to write the code and data values to the internal memory 104. Further, mirroring hardware 112, 113 may include functionality to receive transactions from a respective one of the processing units 102, 103 and to service such transactions by determining whether to provide access to code and/or data values via internal memory 104 or XIP. Mirroring hardware 112, 113 is described in more detail with respect to FIG. 2.

In the example of FIG. 1, external memory 160 and ROM 162 include multiple different items in the form of machine code instructions and data values. For instance, ROM 162 may store primary boot loader (PBL) code and data values, and external memory 160 is shown as including at least secondary boot loader (SBL) code and data values and application code and data values. In this example, the SBL code and data values are designated as being mirroring-only, and they are assumed to be executed only from internal memory, such as internal memory 104. Further in this example, the application code and data values may include multiple (m) regions of machine code instructions and data values, which may correspond to one or more software applications. In this example, the machine code instructions and data values of the one or more software applications may be downloaded into the internal memory 104, such as in an image download, as part of a boot operation.

During boot time, one or both of the processing units 102, 103 may begin reading and executing machine code instructions and/or data values associated with the PBL in the ROM 162. The processing units 102 and 103 may execute the instructions of the PBL to configure the system 100 for operation. In some examples, this includes storing configuration data in internal memory 104 and other memories of the system 100, and may also include copying the SBL from the external memory 160 to the internal memory 104. The instructions of the PBL may cause one or both of the processing units 102, 103 to begin executing the instructions of the SBL to perform further configuration of the system 100 for operation. The instructions of the SBL may also cause the processing units 102 and 103 to begin copying application code and data values to the internal memory 104 and to begin executing the application code. As noted above, the execution of the application data may begin before the copying completes, and the instructions of the SBL may cause the mirroring hardware 112 and 113 to being copying the application code and data values in an order based on the order in which the code and data values is expected to be used by the application.

In that regard, one or both of the processing units 102, 103 may request machine code instructions and/or data values corresponding to the one or more software applications. Specifically, one or both of the processing units 102, 103 may send a transaction to its respective mirroring hardware 112, 113. The respective mirroring hardware 112, 113 may then determine whether to service the transaction by either accessing the machine code instructions and/or data values from internal memory 104 or from external memory 160 (by XIP). In this manner, one or both of the processing units 102, 103 may execute one or more of the software applications even before the machine code instructions and data values of the software applications have been fully loaded into memory cells of internal memory 104.

FIG. 2 is a simplified block diagram of an example mirroring hardware 200, such as either of mirroring hardware 112, 113 of FIG. 1, according to various embodiments. Mirroring hardware 200 includes transaction decoder 202, direct memory access (DMA) engine 204, and multiple region configuration data 210. The multiple region configuration data 210 may be stored in memory internal to the mirroring hardware 200, in registers, or other appropriate place.

In this example, an incoming CPU transaction would be received from a respective processing unit (e.g., 102 or 103), and an outgoing transaction may be performed with respect to either the internal memory or the external memory. Continuing with the example, during boot time, a boot loader configures the mirroring hardware 200 to trigger a mirroring operation. The mirroring hardware 200 performs the mirroring operation by using a technique, such as DMA, to read machine code instructions and data values from memory address ranges of the external memory and to write those machine code instructions and data values to the internal memory. However, the reading and writing operations of the mirroring operation are not instantaneous, so that the mirroring operation may take some amount of time.

During the mirroring operation, a corresponding processing unit (e.g., 102 or 103) may be reset and then start application execution without waiting for the mirroring operation to complete. While the mirroring operation is in progress, the transaction decoder 202 tracks the progress of the mirroring operation, including tracking which memory address ranges of the external memory have been copied to address ranges of the internal RAM. The transaction decoder 202 checks each transaction from the processing unit and compares a requested address of the transaction to the tracked memory address ranges to determine whether the requested machine code instructions or data values have been downloaded to the internal memory.

If the requested machine code instructions or data values have been downloaded to the internal memory, then the transaction decoder 202 may pass the transaction to the internal memory. On the other hand, if the requested machine code instructions or data values have not yet been downloaded to the internal memory, then the transaction decoder 202 performs an address translation corresponding to an address of the external memory and then passes the translated transaction to the XIP module for completion from the external memory.

The mirroring hardware 200 in this example includes support for regions. A region in this example includes a range of memory addresses that may be defined for a particular purpose and may be identified as an entity by the transaction decoder 202. In one example, the SoC has multiple processing units, such as illustrated in FIG. 1. During development, developers may assign code and constants for different cores into different and separate regions with the expectation that the external memory (and internal memory) may serve different processing units. When an address comes in from a transaction, the transaction decoder 202 may check which region corresponds to the requested address.

In another example, some software may be exempted from being downloaded to internal memory. In other words, that software may be designated by the developers as XIP only. The developers may then choose to place that particular software in a region that is dedicated to XIP.

The region data 210 may include a region configuration for each individual region. In this example, FIG. 2 shows the contents of only one of the region configurations, and it is understood that each of the region configurations may be implemented similarly. The RAM address field refers to a starting address in internal memory for the particular region. Similarly, the flash address field refers to a starting address in external memory for the particular region. The region size field indicates a size of the region, so that an address range for the region begins at a starting address and extends through the region size. The current RAM copy size field refers to how much of the region has been copied from external memory to the internal memory. The region control field may contain any appropriate data, such as an indication whether a downloading process for the region has been started and/or completed, restrictions on the region, and the like.

A boot operation may identify a particular region. In one example, the external memory may include four different regions, and the boot process may define that it should download two out of the four regions—one region for code and one region for constants. In this example, the boot process may indicate that only a portion of the contents of the external memory should be downloaded during boot.

In another example, a software application may include 2 MB with a variety of software functions, each of the software functions assigned to a different region. One of the software functions (10 kB) may have a particular characteristic that makes it particularly sensitive to latency, so it may be in a region that is designated (e.g., in the region control field) as being for download to internal memory. By contrast, the remaining software functions are in one or more different regions designated for XIP. In such an example, the boot process may then be programmed to trigger image download for the first region (including the 10 kB) but not for the remaining one or more regions. Such an example further illustrates that a boot process may download some, but not all, contents of the external memory.

In another example, a software application may be larger than the internal memory, such as in an example in which the software application is 2 MB, and the on-chip RAM supports 512 kB. In such an instance, developers may place some software functions (or no software functions) into regions designated for download to internal memory and the remaining software functions into regions designated for XIP.

In yet another example, during runtime, a software application may include multiple software functions stored in multiple regions, but only some of the functions are currently used. In such an instance, the regions corresponding to the currently used software functions may be referred to as “tracked” or “active.” Other regions may be designated inactive or disabled. Additionally or in the alternative, regions of the external memory may not be accessible by a given processing core, and thus not active, due to a lack of permission, a region being generally disabled, a region not containing any code or data values, and/or other reasons. The transaction decoder 202 may monitor usage of the different regions and, thus, be aware of which regions are active and which are not.

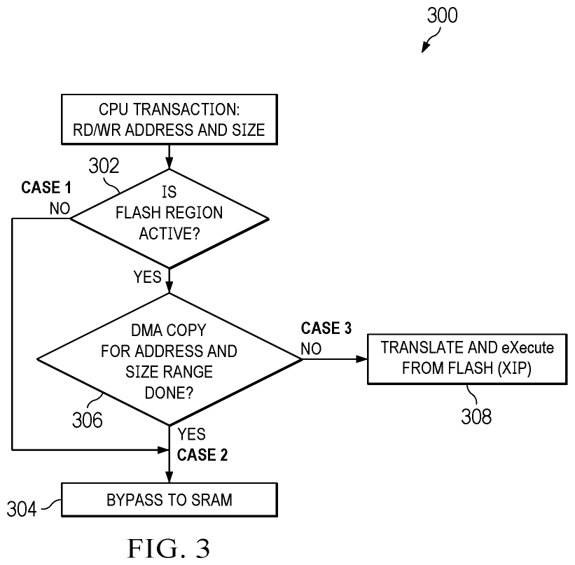

FIG. 3 is an illustration of an example method 300, for fetching data values and machine code instructions, according to various embodiments. Method 300 may be performed by one or more processing units, such as mirroring hardware 200 of FIG. 2. For instance, mirroring hardware 200 may read computer executable code from a memory (e.g., internal to mirroring hardware 200) and then execute that code to provide the functionality described with respect to FIG. 3.

Method 300 begins with the mirroring hardware receiving a transaction from a processing unit, where that transaction may include an indication of a read operation or write operation and a starting address and size. An example of a processing unit that may send a transaction to the mirroring hardware includes processing units 102, 103 of FIG. 1. Action 302 may include the mirroring hardware determining whether the starting address and size of the transaction map to a flash region (e.g., a region of external memory 160 in which code or data values for the transaction are stored), and if so, whether the flash region corresponding to the transaction is active. As noted above, an active region is one that is capable of being accessed by transactions from a processing unit and is not otherwise disabled. Action 302 may include the mirroring hardware comparing the address and size within the transaction to a region configuration to determine which region corresponds to the transaction.

If the flash region is not active, then the mirroring hardware bypasses further processing by providing the transaction to the internal memory (e.g., internal memory 104 and/or other SRAM) at action 304. If the flash region is active, then the mirroring hardware moves to action 306, where the mirroring hardware determines whether the particular address and size of the transaction (an address range) has completed being downloaded from the external memory to the internal memory. If the mirroring hardware determines that the particular address range of the transaction has completed downloading, then the mirroring hardware bypasses further processing by providing the transaction to the internal memory at action 304.

If the address range referred to in the transaction has not been copied to the internal memory, then the mirroring hardware translates the address of the transaction to an external memory address and forwards the transaction to an XIP module at action 308. Method 300 may be repeated for each transaction received by the mirroring hardware from a processing unit.

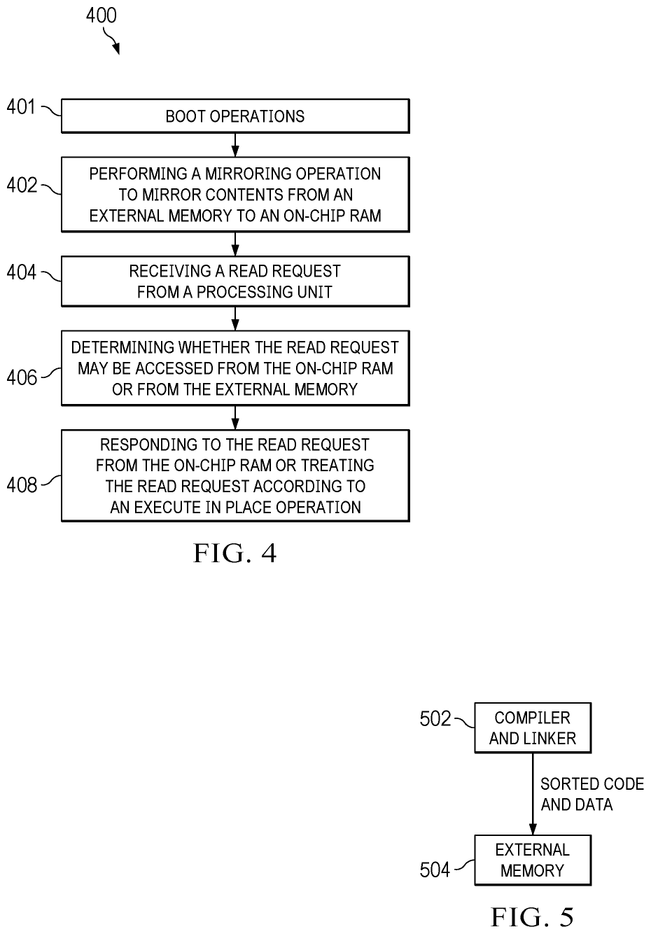

FIG. 4 is an illustration of an example method 400 for processing a read request, including instruction and data fetching, according to various embodiments. Example method 400 may be performed by a processing unit, such as mirroring hardware 200 of FIG. 2. For instance, mirroring hardware 200 may read computer-executable code from a memory (e.g., internal to mirroring hardware 200) and then execute that code to provide the functionality described with respect to FIG. 4.

Action 401 includes performing boot operations. Boot operations may include actions described above with respect to the PBL and SBL, such as the processing units 102, 103 to configure the system for operation, copy the SBL to internal memory 104, and begin the mirroring operation. Action 401 may, in some examples, be performed by one or both of the processing units 102, 103, rather than by mirroring hardware 200.

Action 402 includes performing a mirroring operation to mirror contents from an external memory (e.g., external memory 160) to an on-chip RAM (e.g., internal memory 104). Examples of contents that may be stored in an external memory and then mirrored may include machine code instructions, read-only data values (constants), initialized read-write data values (variables), and the like.

An example of a mirroring operation may include a DMA operation to read a range of addresses from the external memory and to write the contents of that range of addresses to a corresponding range of addresses in the internal memory. In the example of FIG. 1, flash hardware 112 may read a range of addresses from the external memory 160 and write the contents to a corresponding range of addresses in internal (on-chip) RAM 104. In some instances, the DMA operation may read the ranges of addresses in order and then write those ranges of addresses to the internal RAM in the same order, thereby preserving the order of the machine code instructions and data values as it was written into the external memory 160.

Action 404 includes receiving a read request from a processing unit. In the example of FIG. 1, that may include receiving a read request indicating a range of addresses of the internal RAM by the mirroring hardware 112 or 113. The transaction may be received from a respective processing unit 102 or 103. In one example, the read request is generated by the processing unit executing boot loader code, and the boot loader code is programmed to access addresses according to address ranges of the internal RAM. However, the scope of implementations is not limited to any particular utility executed by the processor, whether boot loader code or otherwise.

Action 406 includes determining whether the read request may be accessed from the non-chip RAM or from the external memory. Looking at the example of FIG. 2, the mirroring hardware 200 includes a transaction decoder 202, which tracks address ranges that have been downloaded from the external memory to the internal memory. The mirroring hardware may compare the address range of the transaction to the ranges of addresses that have been mirrored to determine whether the address range of the transaction has completed mirroring. If the range of addresses has completed mirroring, then the read request may be accessed from the on-chip RAM. However, if the range of addresses has not completed mirroring, then the read request may be accessed from the external memory via XIP.

Action 408 includes responding to the read request from the on-chip RAM or treating the read request according to an XIP operation. Action 408 depends on the determination made in action 406.

Method 400 may be performed at boot time or at other times of operation of a processing unit. For instance, method 400 may be used during boot up to reduce latency associated with boot up, thereby providing access to boot software relatively early. However, the scope of implementations is not limited to boot time. Rather, method 400 may be adapted to use when beginning execution of a software function associated with a particular region. For instance, even after boot up, a software application may include a branching operation that accesses a previously inactive software function. Assuming that the particular region is designated for download and has not yet been downloaded, then the system may employ method 400 to reduce latency in startup of the software function. Or put another way, the system may employ method 400 to begin executing the software function even before the software function has been fully downloaded to internal memory. The same is true of method 300.

Various embodiments may provide advantages over other solutions. For instance, actions 406-408 may allow for lower latency at start up for a software application. Specifically, actions 406-408 may avoid a latency penalty that would otherwise be incurred by fully downloading the software application into internal memory before beginning execution of the software application. Furthermore, actions 406-408, in combination with action 402, may set up the system to achieve the benefits of execution from internal memory subsequent to the startup process and during normal use.

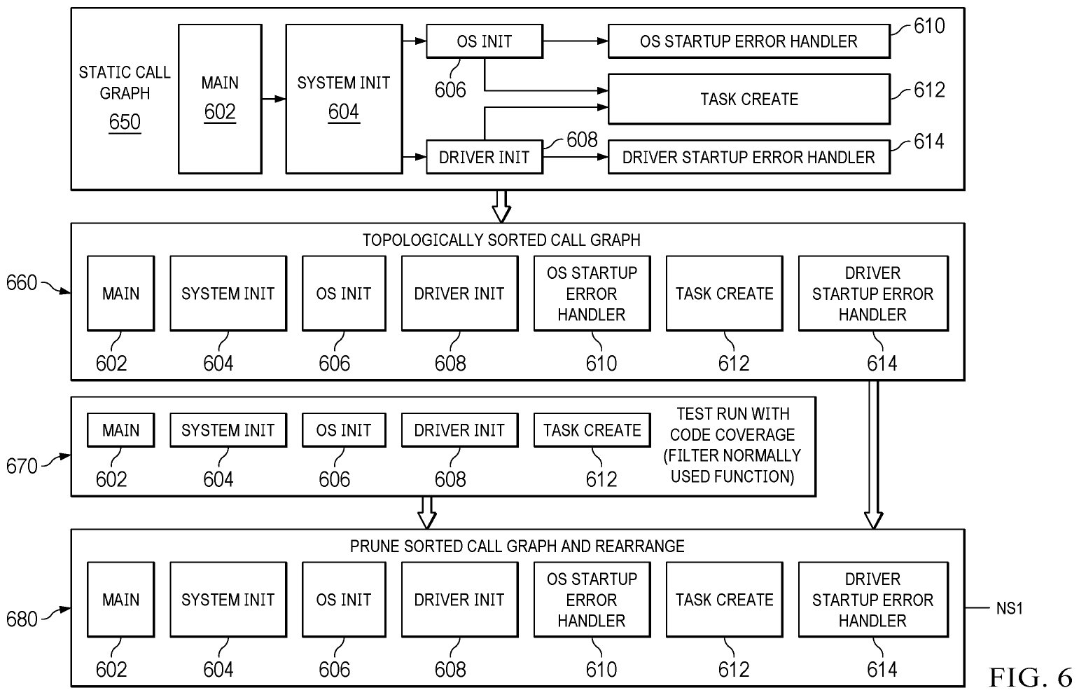

FIG. 5 is an illustration of an example process, which may be used to generate machine code instructions and data values to be stored in a memory, such as an external memory, according to various embodiments. The example process 500 may be performed during a development phase in which a compiler and linker place machine code instructions and data values to improve execution speed and effective latency in a system, such as the system of FIG. 1. Also, for convenience, the term “data” may be used to refer to either or both of machine code instructions and data values, which are generated by the compiler and placed by the linker.

The process begins at the compiler and linker 502, which provides sorted data to be saved to external memory 504. An example of external memory 504 includes external memory 160 of FIG. 1. A compiler is a tool in software development that translates high-level programming code, such as C, into machine code instructions that can be executed by a CPU. During the compilation process, the compiler analyzes the source code, performs syntax and semantic checks, and generates an intermediate representation. This representation includes machine code instructions, constants, and variables, each associated with pseudo-addresses.

The compiler translates the high-level code into a series of machine code instructions specific to the target architecture. Constants and variables are assigned pseudo-addresses in this process, representing memory locations that will later be mapped to physical addresses during the linking phase. These pseudo-addresses provide a logical abstraction, allowing the compiler to generate code without knowledge of the final memory layout.

The linker is a component that follows the compilation phase. It takes the output produced by the compiler, including the machine code instructions and the associated pseudo-addresses for constants and variables. The linker's primary responsibility is to assign actual physical addresses to these pseudo-addresses, resolving memory locations and creating a coherent executable program. The linker may also resolve external references, linking together various modules and libraries to form a complete and executable program. The linked output (sorted data) may then be loaded into external memory 504. The combination of the compiler and linker 502 may enable the transformation of human-readable code into machine-executable instructions while managing the complexities of memory organization and inter-module dependencies.

Further in this example, the compiler and linker 502 may include additional functionality. That additional functionality is described in more detail with respect to FIG. 6. Specifically, the compiler and linker 502 may be configured to perform at least one initial test run on a software application to generate function call graphs. Furthermore, the compiler and linker 502 may be configured to rearrange software functions of the software application to store the data corresponding to those software functions into physical address ranges based on an expected order of a read operation of the external memory during a mirroring operation.

Of course, the scope of implementations is not limited to only a compiler or only a linker. Rather, the functionality to generate call graphs and arrange the software functions may be included within a compiler or linker or separate from a compiler or linker.

FIG. 6 is an illustration of example software functions, arranged within example call graphs 650-680, according to various embodiments. As described in more detail below, the actions of FIG. 6 may be performed during development phase to place data of various software functions into address ranges of memory (e.g., external memory 160, memory 504) to improve execution speed and effective latency in a system (e.g., system 100 of FIG. 1). In one example, the actions described with respect to FIG. 6 may be performed by one or more components that are illustrated by the compiler and linker 502 of FIG. 5.

Call graph 650 identifies a plurality of discrete software functions 602-614 that may be invoked during execution of the software application. Some software applications may have more or fewer functions than are shown in FIG. 6, and the scope of implementations may be adapted to any appropriate software application. Call graph 650 is a static call graph, and it illustrates, among other things, that the software application may include branching instructions. For instance, execution of software function 604 may lead to either function 606 or function 608, depending upon a status of some condition. Furthermore, execution of function 606 may lead to execution of function 610 or function 612, depending upon a status of another condition. Similarly, execution of function 608 may lead to execution of function 612 or 614, depending upon a status of yet another condition.

As a result of the branching instructions of the software application, it is not entirely guaranteed that execution of the software application may be performed in any particular order once function 604 has been executed. However, the compiler and linker 502 is configured in this example to perform one or more test runs to determine which order of the different functions 602-614 is more likely and then to arrange the data accordingly.

Call graph 660 is topologically sorted so that it does not illustrate possible branching. Nevertheless, it illustrates each of the software functions 602-614 in a possible order of execution.

The compiler and linker 502 is configured to perform the one or more test runs to generate call graph 670. The test run may be performed under any appropriate condition. One condition that may be used in some examples assumes startup of the software application, rather than post-startup execution during normal operation.

According to the test run, testing startup of the software application, the compiler and linker 502 may determine an order of the software functions during startup and, further, whether some of the functions are executed or are not executed during startup. Graph 670 illustrates in this example that software functions 602, 604, 606, 608, and 612 are executed during startup. However, the test run graph 670 indicates that software functions 610 and 614 may not be executed during startup, though they may be executed at a later time. Of course, each software application is different, and the scope of implementations may be adapted for any of a variety of software applications in any appropriate order whether or not executed.

Graph 680 is an example of a pruned and sorted call graph based upon the test run. For instance, the compiler and linker 502 may then create graph 680 by ordering the software functions 602, 604, 606, 608, and 612 according to their order of execution during startup and then adding those software functions 610, 614 which were not used during startup.

The graph 680 defines an order in which data of each of the software functions 602-614 are to be written to physical addresses of a memory. For instance, software function 602 may be written to a first address range 0000-1000, software function 604 may be written to an address range 1001-2000, software function 606 may be written to an address range 2001-3000, software function 608 may be written to an address range 3001-4000, software function 612 may be written to an address range 4100-5000, software function 610 may be written to an address range 5100-6000, and software function 614 may be written to an address range 6100-7000. Such address ranges are for example only, and it is understood that not all software functions may occupy same sized address ranges and further that different memory devices may support differently sized address ranges.

As noted above, some embodiments may use DMA to read data from an external memory and then to write the data to an on-chip memory. In some examples, DMA may read the address ranges in sequence (0000-1000, 1001-2000, 2001-3000, 3100-4000, 4100-5000, 5100-6000, and 6100-7000) and then write those address ranges in the same sequence into address ranges of the on-chip memory. In other words, the mirroring operation may write the address range 0000-1000 first in time, write the address range 1001-2000 second in time, and on and on until writing the address range 6100-7000 last in time.

Returning to the method 400 of FIG. 4, the mirroring operation 402 may be performed using the sequence of address ranges of the DMA read operation and write operations described above. For instance, the mirroring operation may first mirror the address range corresponding to the software function 602. As the software function 602 is most likely to be executed first during startup, there is a higher likelihood that the data associated with software function 602 have been written into the non-chip memory by the time a transaction corresponding to software function 602 arrives at the mirroring hardware 200 from a processing unit. As the mirroring operation continues, the mirroring hardware 200 reads the data in the sequence of address ranges above and, thus, mirrors content corresponding to software function 604 next, then software function 606, and on and on in the order shown in graph 680.

As a result, transactions from the processor are more likely to be serviced from the on-chip RAM rather than from the external memory, even when some content of the software application has not yet been mirrored to the on-chip RAM. Nevertheless, it is to be expected that some use cases in embodiments may include misses, which may invoke an XIP operation to access data from the external memory. However, the sorting, pruning, and ordered writing in the external memory, as described above with respect to FIGS. 5-6, may be expected to increase a number of hits and decrease a number of misses. A potential advantage of such an embodiment may include a faster start up process for a software application, which may be beneficial for systems in which latency is disadvantageous.

For instance, some embedded systems include automotive uses, where a user of the automobile expects full functionality almost immediately after accessories are turned on and after a motor is turned on. Such embedded systems may benefit from lower latency during startup, giving the embedded system full functionality or nearly full functionality more quickly after accessories are turned on or after a motor is turned on.

The term “semiconductor die” is used herein. A semiconductor device can be a discrete semiconductor device such as a bipolar transistor, a few discrete devices such as a pair of power FET switches fabricated together on a single semiconductor die, or a semiconductor die can be an integrated circuit with multiple semiconductor devices such as the multiple capacitors in an analog-to-digital (A/D) converter. The semiconductor device may include passive devices such as resistors, inductors, filters, sensors, or active devices such as transistors. The semiconductor device may be an integrated circuit with hundreds or thousands of transistors coupled to form a functional circuit, for example a microprocessor or memory device. The semiconductor device may also be referred to herein as a semiconductor device or an integrated circuit (IC) die.

The term “semiconductor package” is used herein. A semiconductor package has at least one semiconductor die electrically coupled to terminals and has a package body that protects and covers the semiconductor die. In some arrangements, multiple semiconductor dies may be packaged together. For example, a power metal oxide semiconductor (MOS) field effect transistor (FET) semiconductor device and a second semiconductor device (such as a gate driver die, or a controller die) may be packaged together to from a single packaged electronic device. Additional components such as passive components, such as capacitors, resistors, and inductors or coils, may be included in the packaged electronic device. The semiconductor die is mounted with a package substrate that provides conductive leads. A portion of the conductive leads form the terminals for the packaged device. In wire bonded integrated circuit packages, bond wires couple conductive leads of a package substrate to bond pads on the semiconductor die. The semiconductor die may be mounted to the package substrate with a device side surface facing away from the substrate and a backside surface facing and mounted to a die pad of the package substrate. The semiconductor package may have a package body formed by a thermoset epoxy resin mold compound in a molding process, or by the use of epoxy, plastics, or resins that are liquid at room temperature and are subsequently cured. The package body may provide a hermetic package for the packaged device. The package body may be formed in a mold using an encapsulation process, however, a portion of the leads of the package substrate are not covered during encapsulation, these exposed lead portions form the terminals for the semiconductor package. The semiconductor package may also be referred to as a “integrated circuit package,” a “microelectronic device package,” or a “semiconductor device package.”

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. A method comprising:
copying a set of data from a first memory to a second memory;
monitoring a progress of the copying of the set of data;
receiving a transaction from a processing unit during the copying of the set of data; and
determining, based on the monitoring, whether to perform the transaction using the set of data as stored in the first memory or the set of data as stored in the second memory; and
performing the transaction.

2. The method of claim 1, wherein the transaction comprises a read request identifying an address and a size of a subset of the set of data.

3. The method of claim 2, wherein the address comprises an address within the second memory.

4. The method of claim 1, further comprising:
determining that a subset of the set of data is not available in the second memory;
translating an address received from the processing unit to an address corresponding to a location in the first memory; and
accessing the subset of the set of data from the first memory according to the address corresponding to a location in the first memory.

5. The method of claim 1, further comprising:
determining that a subset of the set of data is available in the second memory; and
accessing the subset of the set of data from the second memory according to an address received from the processing unit.

6. The method of claim 1, wherein the first memory comprises external memory and wherein the second memory comprises on-chip random access memory (RAM).

7. The method of claim 1, wherein the copying comprises:
sequentially reading contents from a first plurality of addresses of the first memory; and
writing the contents to a second plurality of addresses of the second memory in a same order in which the contents were read from the first plurality of addresses.

8. The method of claim 7, wherein the transaction is associated with execution of an application, further wherein the set of data is associated with the application, and wherein the first plurality of addresses correspond to an order in which the set of data is accessed during execution of the application.

9. The method of claim 1, wherein the transaction is associated with execution of an application, and further wherein the set of data is associated with the application and includes machine code instructions and data values, the method further comprising:
at the processing unit, beginning executing the application before the set of data has been written to the second memory in its entirety.

10. A system on-chip (SoC) comprising:
a central processing unit (CPU);
first memory; and
hardware logic disposed within a communication path between the CPU and the first memory, wherein the hardware logic is configured to:
perform a mirroring operation on data from a second memory to the first memory;
receive a request from the CPU, wherein the request references an address in the first memory;
determine whether to respond to the request using the data as stored in the first memory or the data as stored in the second memory based on whether the address referenced by the request has been written by the mirroring operation; and
respond to the request.

11. The SoC of claim 10, wherein the hardware logic is configured to:
translate the address in the first memory to an address in the second memory.

12. The SoC of claim 10, wherein the CPU is configured to:
begin executing an application, associated with the data, before the mirroring operation is complete.

13. The SoC of claim 10, wherein the hardware logic comprises direct memory access (DMA) logic configured to perform the mirroring operation, further wherein the first memory comprises on-chip random access memory (RAM) and the second memory comprises external memory.

14. The SoC of claim 13, wherein the hardware logic is configured to, as part of the mirroring operation:
sequentially read the data from a first plurality of addresses of the second memory; and
write the data to a second plurality of addresses of the first memory in a same order in which the data was read from the first plurality of addresses.

15. A software programming tool comprising:
a compiler configured to:
produce machine code instructions and data values and to produce pseudo-addresses for the machine code instructions and the data values, further wherein the machine code instructions and the data values correspond to a software application; and
a linker configured to:
receive the machine code instructions and the data values from the compiler;
perform a test run on the software application, including determining an execution order of a plurality of discrete software functions of the software application; and
write the machine code instructions and the data values to a nonvolatile memory, including placing the machine code instructions and the data values according to the execution order of the plurality of discrete software functions.

16. The software programming tool of claim 15, wherein the linker is configured to write the machine code instructions and the data values to the nonvolatile memory by writing to an external memory associated with a system on-chip.

17. The software programming tool of claim 15, wherein the data values include read-only data values and read and write data values.

18. The software programming tool of claim 17, wherein the linker is configured to write the machine code instructions and the read-only data values and read and write data values into address ranges of the nonvolatile memory, wherein an order of the address ranges corresponds to the execution order.

19. The software programming tool of claim 15, wherein the linker is configured to perform the test run by determining the execution order of the plurality of discrete software functions at startup time of the software application.

20. The software programming tool of claim 15, wherein the plurality of discrete software functions include a branching instruction, wherein the linker is configured to perform the test run by determining the execution order by determining a result of the branching instruction at startup time of the software application.
